(19) United States
(12) Patent Application Publication
(10) Pub. No.: US 2021/0027652 A1
(43) Pub. Date: Jan. 28, 2021

(54) STRETCHING FACILITY AND METHOD FOR STRETCHING, STRENGTHENING, AND BALANCING MUSCLES

(71) Applicant: Krystian Sands, Whittier, CA (US)

(72) Inventor: Krystian Sands, Whittier, CA (US)

(21) Appl. No.: 16/523,678

(22) Filed: Jul. 26, 2019

(51) Int. Cl. G09B 19/00; A61H 33/06; A63B 21/055; A63B 21/00; A61G 13/00; A63B 26/00; A63B 4/00; A63B 22/16; E04H 3/14

(52) U.S. Cl. CPC G09B 19/003; A61H 33/06; A63B 21/055; A63B 21/4037; A61G 13/009; A63B 21/072; A63B 4/00; A63B 22/16; E04H 3/14; A61H 2033/061; A61H 2033/068; A63B 26/003

(57) ABSTRACT

A stretching facility and method for stretching and strengthening muscles provides coach-assisted muscle and tendon therapy to a facility member, including: assisted stretching services in which a coach positions and maintains the limbs of a facility member in a proper stretch position, at a proper tension, and for an appropriate amount of time; assisted muscle strength training in which the coach provides resistance to the muscles for building the strength, anaerobic endurance, and size of skeletal muscles; assisted balance and coordination training in which the coach stabilizes the leg and core muscles to improve stability and balance; a sauna and spa session for the facility member to relax muscles and exfoliate the skin; a relaxation session where the facility member partakes in soothing activities to reduce tension in the muscles and mind; a chiropractor treatment; and an attire changing portion for the facility member to shower and change training attire.

### FIELD OF THE INVENTION

The present invention relates to a stretching facility and method for stretching, strengthening, and balancing muscles. More so, the present invention relates to a stretching facility and method that provides coach-assisted muscle and tendon therapy to a facility member through eclectic muscle, exoskeleton, and holistic exercises, treatments, and activities, including: assisted stretching services in which a coach positions and maintains the limbs, fingers, neck, and feet of a facility member in a proper stretch position, at a proper tension, and for an appropriate amount of time; assisted muscle strength training in which the coach provides resistance to the muscles to induce muscular contraction for building the strength, anaerobic endurance, and size of skeletal muscles; assisted balance and coordination training in which the coach stabilizes the leg and core muscles to improve stability and balance; a sauna and spa session for the facility member to relax muscles and exfoliate the skin; a relaxation session in which the facility member partakes in soothing activities to reduce tension in the muscles and mind creating a unique holistically-based treatment; a chiropractor treatment in which a chiropractor treats mechanical disorders of the musculoskeletal system; and myriad muscle stretching and strengthening techniques designed to limber and heal the muscles, tendons, and spine, so as to reduce stress, increase blood circulation, enhance posture, and induce a relaxed state.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Stretching tight muscles are utilized for treating athletic, neurological or orthopedic injuries to the legs, arms, back, hands, hip, toes, neck, etc., Stretching helps promote flexibility, increases the range of motion and therefore minimizes the chances of re-injuring the injured limb. In order to achieve the maximum benefits, stretching should be done in a slow, gradual fashion, with the limb, neck, back, etc., stretched only so far as it can go without discomfort. The stretch should be maintained at the maximum level for a few seconds, and then the tension relaxed. This should then be repeated several times for maximum benefit. It is important that the stretch is maintained without bouncing, which can cause injuries.

It is known in the art that most forms of muscle stretching and strengthening exercises, whether directed to strength training programs or aerobic cardiovascular workouts, cause the involved muscles to contract in order to flex the associated body part or region controlled thereby. Stretching after exercise can help to relax tension on muscles that have been exercised, and hence, subjected to repeated contraction. Stretching before or after exercise can, therefore, be an important part of any strength/endurance program, as well as being believed to provide independent health-related advantages when used alone.

Other proposals have involved stretching and strengthening centers and methods for developing muscles and tendons. The problem with these stretching and strengthening methods is that they do not combine stretching, strengthening, and relaxing techniques to create a synergetic effect on the muscles. Even though the above-cited stretching and strengthening centers and methods meet some of the needs of the market, a stretching facility and method for stretching and strengthening muscles that provides coach-assisted muscle and tendon therapy to a facility member through eclectic muscle, exoskeleton, and holistic exercises, treatments, and activities, including development of balance and coordination, is still desired.

### SUMMARY

Illustrative embodiments of the disclosure are generally directed to a stretching facility and method for stretching and strengthening muscles. The stretching facility and method provide coach-assisted muscle and tendon therapy to a facility member through eclectic muscle, exoskeleton, and holistic exercises, treatments, and activities. The stretching facility and method are unique in that it combines stretching and strengthening techniques with relaxation and exoskeleton treatment to create a synergetic effect on the body. Each stretching, strengthening, balancing, and relaxation session builds on the others to provide a holistic experience for the muscles and well-being of the facility member.

In some embodiments, the stretching facility and method may include an entry portion comprising of a desk and a member identification device that regulate the entry of the facility member into the stretching facility. The stretching facility and method may further include a coach that assists a facility member with stretching, strengthening, balancing, relaxing, and coordination techniques. In a stretching portion of the stretching facility, the coach positions and maintains the limbs of a facility member in a proper stretch position, at proper tension, and for an appropriate amount of time. Multiple massages therapies are provided, including, without limitation, deep tissue massage, trigger point massage, hot stone, therapy, and sports massage therapy. In other words, these different kinds of massage therapies are provided to stretch the users' muscles. For example, massage therapies can be relaxing, disengaging, and releasing trigger points.

In other embodiments, the stretching facility includes a strengthening portion for assisted muscle strength training in which the coach provides resistance to the muscles of the facility member to induce muscular contraction for building the strength, anaerobic endurance, and size of skeletal muscles. In other embodiments, the stretching facility has a balancing portion where the coach provides assisted balance and coordination training, stabilizing the leg and core muscles of the facility member to improve stability and balance.

Additionally, the stretching facility and method provide a dry heat portion, such as a sauna; and a wet heat portion, such as a spa. The dry and wet heat portions help the facility member relax muscles and exfoliate the skin. The stretching facility and method further include a relaxation session in which the facility member partakes in eclectic soothing activities to reduce tension, and holistically treat the muscle and mind.

In one alternative embodiment, the stretching facility and method may include chiropractor treatment in which a chiropractor treats mechanical disorders of the musculoskeletal system of the facility member. However, the stretching facility and method may also utilize myriad techniques designed to limber and heal the muscles, tendons, and spine, so as to reduce stress, increase blood circulation, enhance posture, and induce a relaxed state in the facility clients. Furthermore, the stretching facility and method also can improve the respiratory activities, and further increase the amount of the fresh air being inhaled into the clients' lungs.

One objective of the present invention is to provide a stretching facility and method in which a coach properly stretches the muscles of a facility member in a slow, gradual fashion, and where the coach or the facility member controls the amount of stretch.

Another objective is to limber and heal the muscles, tendons, and spine, so as to reduce stress, increase blood circulation, enhance posture, and induce a relaxed state in the facility clients.

Another objective is to provide a stretching, strengthening, and balancing classes to the facility clients, and the facility clients can be guided by the associated instructors to perform therapy activities, or they can perform the stretching, strengthening, and balancing activities by themselves.

Another objective is to provide an open area for the facility clients, wherein the facility clients can self-stretching, self-strengthening, and self-balancing in the open area, and the therapists also can provide massage therapies to the facility clients in the open area.

Another objective is to provide a stretching facility and method in which a coach assists a facility member with muscle strengthening and balance.

Another objective is to assist elderly people who struggle with their balanced strength and flexibility, and especially those who dance or play sports need all of the aforementioned services on a regular basis.

Another objective is to reduce injuries through stretching techniques.

Another objective is to provide a coach to facilitate performing the stretches by a facility member.

Yet another objective is to provide a sequence of stretches that is consistent with a variety of more advanced exercises or massage treatments.

Yet another objective is to provide a simple sequence of stretches to address the posture misalignment.

Yet another objective is to provide a sequence of stretches that can be easily remembered and executed in a particular sequence.

Yet another objective is to provide a relaxation session in which the facility member can meditate, eat healthful foods, drink blended health shakes and drinks, reflect, ingest herbs, and listen to soothing music or lectures.

Yet another objective is to provide a sauna and/or spa for the facility member to relax the muscles and exfoliate the skin.

Yet another objective is to provide an inexpensive coach-assisted stretching facility for stretching and strengthening muscles.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary stretching facility for stretching and strengthening muscles, in accordance with an embodiment of the present invention; and

FIG. 2 illustrates a flowchart of an exemplary method for stretching and strengthening muscles in a stretching facility, in accordance with an embodiment of the present invention.

FIG. 3 illustrates that a coach positions and maintains the shoulders and the feet of a facility member in a proper stretch position, at the proper tension.

FIG. 4 illustrates that a coach positions and maintains the feet of a facility member in a proper stretch position, at the proper tension.

FIG. 5 illustrates that a coach positions and maintains the feet of a facility member in a proper stretch position, at the proper tension.

Like reference numerals refer to like parts throughout the various views of the drawings.

### DETAILED DESCRIPTION OF THE INVENTION

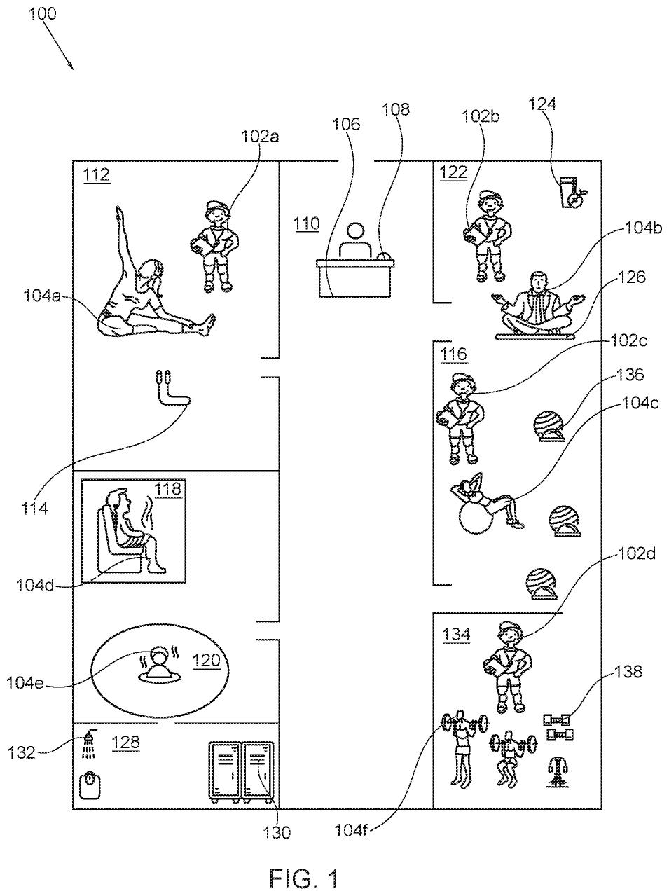

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

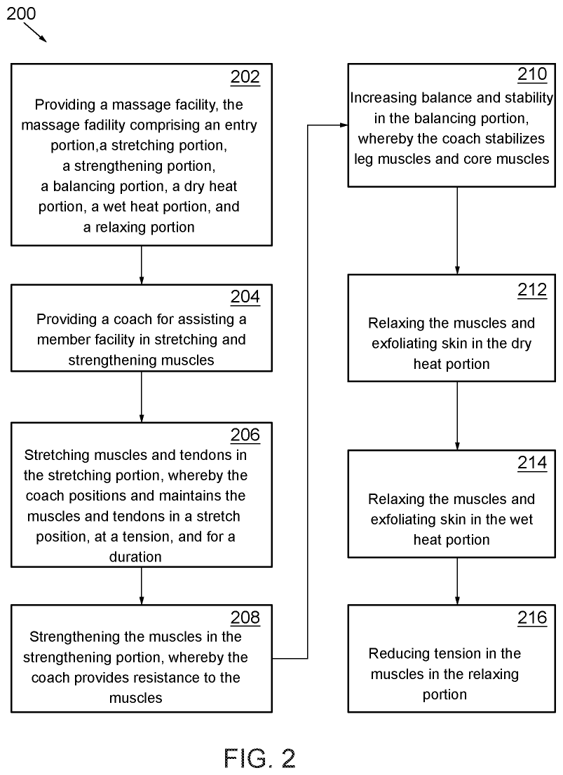

A stretching facility 100 and method 200 for stretching and strengthening muscles is referenced in FIGS. 1-2. The stretching facility 100 is a center where a facility member 104a-f can selectively participate in stretching, strengthening, balancing, coordination, and relaxing techniques for the muscles and tendons, wherein the above-mentioned techniques for muscles and tendons can be, but not limited to, different kinds of massage therapies, including deep tissue massage, trigger point massage, hot stone massage, and sport massage. The stretching facility 100 provides at least one coach 102a-d that assists the facility member 104a-f in the various muscle and tendon exercises, providing hands-on manipulation of the facility member's 104a-f muscles and tendons, along with motivation, suggestions, comments, and long term muscle development plans. The muscle and tendon stretching and strengthening exercises may include muscle, exoskeleton, and holistic exercises, treatments, and activities that the facility member 104a-f can select and/or the coach 102a-d can recommend.

The stretching facility 100 is unique in that it combines stretching and strengthening techniques with relaxation, coordination, and even in some embodiments, exoskeleton treatment from a chiropractor. This works to create a synergetic effect on the muscles. Each stretching, strengthening, balancing, and relaxation session builds on the others to provide a holistic experience for the muscles and well-being of the facility member 104a-f. For example, the coach 102a-d can provide the facility member 104a-f with a deep tissue massage to the calves, followed by a calf/lower leg strengthening session to increase circulation in the legs and minimize cramping in the calves.

As referenced in FIG. 1, the stretching facility 100 may include a completely enclosed gym; or a partially outdoor and partially indoor training facility. The stretching facility 100 may also include, without limitation, a covered gym, an outdoor facility, a field, and a fitness center. The stretching facility 100 may have numerous rooms for the different types of stretching, strengthening, and relaxing activities, and for different kinds of massage therapies, including the deep tissue massage, the trigger point massage, the hot stone massage, and the sport massages. For example, a sauna in one room, weights in a second room, and stretching equipment in an adjacent room (FIG. 1).

In one embodiment, the stretching facility 100 provides an entry portion 110 through which the facility member 104a-f enters and exits. The entry portion 110 serves as a gateway to ensure the membership requirements are fulfilled, and also to ensure that the facility member 104a-f is provided with training equipment and answers to questions. In one non-limiting embodiment, the entry portion 110 includes a desk 106 and a member identification device 108 that regulate the entry of the facility member 104a-f into the stretching facility 100. The member identification device 108 may include a scanner that scans a member identification card, members' fingerprints, or simply a list of facility members 104a-f. In some embodiments, a facility employee may serve at the desk 106 to assist the facility member 104a-f.

In addition, the stretching facility 100 may also include an attire changing portion 128 where the facility member 104a-f can change training attire, shower 132, and store valuables. The attire changing portion 128 may include a shower 132, a locker 130, a scale, and a safety lock for storing valuables.

The stretching facility 100 and method 200 may further provide at least one coach 102a-d that assists at least one facility member 104a-f with stretching, strengthening, balancing, and relaxing techniques. The coach 102a-d generally provides hands-on personal assistance to the facility member. The coach 102a-d works directly with the facility member 104a-f to ensure that the proper stretching, strengthening, and balancing exercises are employed. The coach 102a-d may also record the training sessions to accumulate a history of the facility member 104a-f. The coach 102a-d may include a personal trainer or a massage therapist. In some embodiments, the training sessions can be, but not limited to, 30 to 60 minutes long. Though in other embodiments, different durations of training may be performed, depending on the type of session and needs of the facility member 104a-f.

Looking again at FIG. 1, the stretching facility 100 comprises a stretching portion 112, which may include a room consisting of stretching tables, elastic bands 114, and other stretch-related training equipment. Those skilled in the art will recognize that working out muscle tension during a massage reduces chronic pain, as well as acute or short-term stress. And while bad posture can become a bad habit—massage and stretching for losing muscles and joints can reinforce the body's natural movements. It is also known that muscle tension constricts blood circulation. Thus, massages help release chronically tense and tightened muscles, so as to increase blood flow and help flush toxins from the body.

In one non-limiting embodiment, the coach 102a positions and maintains the limbs of a facility member 104a in a proper stretch position, at proper tension, and for an appropriate amount of time. The coach 102a helps the facility member 104a in a slow, gradual fashion, with the limb stretched only so far as it can go without discomfort. The coach 102a maintains the stretch at the maximum level for seconds, and then the tension relaxed. The coach 102a repeats this stretching motion several times for maximum benefit. The coach 102a is also aware that the stretch is maintained without bouncing, which may cause injuries.

In yet another embodiment, the facility member 104a can perform a Pilates class in the stretching portion 112, wherein the coach 102a may provide the Pilates classes to the facility member 104a, or the facility member 104a can perform the Pilates classes by themselves. It is worth to mention that the facility member 104a in the stretching portion 112 can utilize Pilates mats, reformers, chairs, tables, etc.

Multiple stretching types are provided, including, without limitation, deep tissue massage, trigger point massage, and sports massage therapy. In another embodiment, the coach 102a positions and maintains the muscles and tendons in the stretching portion 112, through various stretching techniques, including, without limitation, deep tissue massage, Swedish massage, trigger point massage, and sports massage therapy.

The coach 102a may perform a deep tissue massage, focusing on the deepest layer of muscles to target knots and release chronic muscle tension. The deeper pressure is beneficial in releasing chronic muscle tension. In a deep tissue massage, the coach 102a focuses on the deepest layers of muscle tissue, tendons, and fascia (the protective layer surrounding muscles, bones and joints).

The coach 102a may also perform a trigger point massage. It is known in the art that a trigger point is a tight area within muscle tissue that causes pain in other parts of the body. A trigger point in the back, for example, may produce referral pain in the neck. The neck, now acting as a satellite trigger point, may then cause pain in the head. The pain may be sharp and intense or a dull ache. The trigger point massage helps alleviate the source of the pain through cycles of isolated pressure and release. In this type of massage for trigger point therapy, the facility member 104a actively participates through deep breathing as well as identifying the exact location and intensity of the discomfort.

The coach 102a may also perform sports massage therapy to the facility member 104a. For athletes of every kind, each therapeutic massage is specific to their sport, with a focus on a particularly troublesome area like a knee or shoulder. Sports massage therapy compared to other modalities is its ability to target muscle-tendon junctions. The coach 102a is trained to perform these various massage therapies according to the needs and requirements of the facility member 104a.

Looking again at FIG. 1, the stretching facility 100 includes a strengthening portion 134, which may include a large gym floor where the coach 102d assists the facility member 104a-f in assisted muscle strength training. In some embodiments, the coach 102d provides resistance to the muscles of the facility member 104f to induce muscular contraction for building the strength, anaerobic endurance, and size of skeletal muscles. For example, the coach 102d may press down against the limbs of the facility member 104f as the facility member 104f attempts to raise the limbs against the resistance created by the coach 102d. In some embodiments, the strengthening portion 134 may include an exercise ball and weights 138 for the facility member 104f to utilize while strength training.

As discussed above, the stretching facility 100 also has the capacity to develop balance for the facility member 104c. This may be especially useful for assisting elderly people who struggle with their balanced strength, and especially those who dance or involve in sport activities. For this reason, the stretching facility 100 has a balancing portion 116 where the coach 102c provides assisted balance and coordination training, stabilizing the leg and core muscles of the facility member 104c to improve stability and balance. The coach 102c may utilize various equipment for developing the facility member's 104c balance, including, without limitation, a balance board, a balance beam, and a stability ball 136.

Additionally, the stretching facility 100 and method 200 provides a dry heat portion 118, such as a sauna. The facility member 104d may enter the dry heat portion 118 to relax muscles, sweat toxins from the body, and exfoliate the skin. Similarly, the stretching facility 100 includes a wet heat portion 120, such as a spa. The wet heat portion 120 helps the facility member 104e relax muscles and exfoliate the skin. The facility member 104d, 104e may utilize the dry and wet heat portions 118, 120 before or after any of the stretching, strengthening, and balancing portion 116 of the stretching facility 100. In addition, the coach 102a may provide the stretching, strengthening, and balancing instructions to the facility member 104d in the dry and wet heat portions 118, 120, wherein the facility member 104d also can perform the stretching, strengthening, and balancing activities by themselves in the dry and wet heat portions 118, 120.

The stretching facility 100 is unique in providing a relaxing portion 122 in which the facility member 104b partakes in eclectic soothing activities to reduce tension in the muscles and mind; and also holistically treat the muscle and mind. The coach 102b may provide motivation and technique assistance in the relaxing portion 122. The relaxation-related activities may include, without limitation, yoga, deep breathing, consuming juices, ingesting herbs, and listening to lectures and soothing music. Related relaxing items and equipment used may include, without limitation, a yoga mat 126, a padded supportive panel, a juice bar 124, and recordings of lectures and soothing music.

The relaxation techniques create a unique synergy with the stretching, strengthening, and balancing techniques discussed above. The facility member 104b may utilize the relaxing portion 122 before or after any of the stretching, strengthening, and balancing portion 116 of the stretching facility 100. For example, the facility member 104b may partake in a deep tissue massage in the stretching portion 112 of the stretching facility 100, followed by a vegetable juice and motivational lecture in the relaxing portion 122 of the stretching facility 100.

In one alternative embodiment, the stretching facility 100 and method 200 may include chiropractor treatment in which a chiropractor treats mechanical disorders of the musculoskeletal system of the facility member 104a-f. However, the chiropractor may or may not be operable in the stretching facility 100, depending on the embodiment of the invention. It is significant to note that improving the posture of the facility member 104a-f can involve both muscle development through stretching and strengthening, as well as spinal adjustment treatments with a chiropractor. However, the stretching facility 100 and method 200 may also utilize myriad other techniques designed to limber and heal the muscles, tendons, and spine, so as to reduce stress, increase blood circulation, enhance posture, and induce a relaxed state in the facility member 104a-f.

In yet another embodiment, the stretching facility 100 and method 200 may comprise cardio machines configured to allow the facility member 104a-f for warming up. For example, cardio machines can be rowing machines, treadmills, stationary bikes, step machines, etc.

In still yet another embodiment, the stretching facility 100 and method 200 can be utilized by people of all ages. In addition, especially, the elderly, active individuals, and rehabilitation patients also can utilize the stretching facility 100 and the method 200.

The stretching facility 100 further comprises a cooled room configured to allow the facility member 104a-f being cooled down, wherein a temperature in the cooled room is approximately 15 Celsius to 25 Celsius. In one aspect, the cooled room may comprise fans and ice packs, so as to facilitate the facility member 104a-f to immediately cool down their bodies' temperature.

FIG. 2 illustrates a flowchart of an exemplary method 200 for stretching and strengthening muscles in a stretching facility. The method 200 may include an initial Step 202 of providing a stretching facility, the stretching facility comprising an entry portion, a stretching portion, strengthening portion, a balancing portion, a dry heat portion, a wet heat portion, and a relaxing portion. The method 200 may further comprise a Step 204 of providing a coach for assisting a member facility in stretching and strengthening muscles. A Step 206 includes stretching muscles and tendons in the stretching portion, whereby the coach positions and maintains the muscles and tendons in a stretch position, at a tension, and for a duration.

In some embodiments, a Step 208 comprises strengthening the muscles in the strengthening portion, whereby the coach provides resistance to the muscles. A Step 210 includes increasing balance and stability in the balancing portion, whereby the coach stabilizes leg muscles and core muscles. In some embodiments, a Step 212 may include relaxing the muscles and exfoliating skin in the dry heat portion. A Step 214 comprises relaxing the muscles and exfoliating skin in the wet heat portion. A final Step 216 includes reducing tension in the muscles in the relaxing portion.

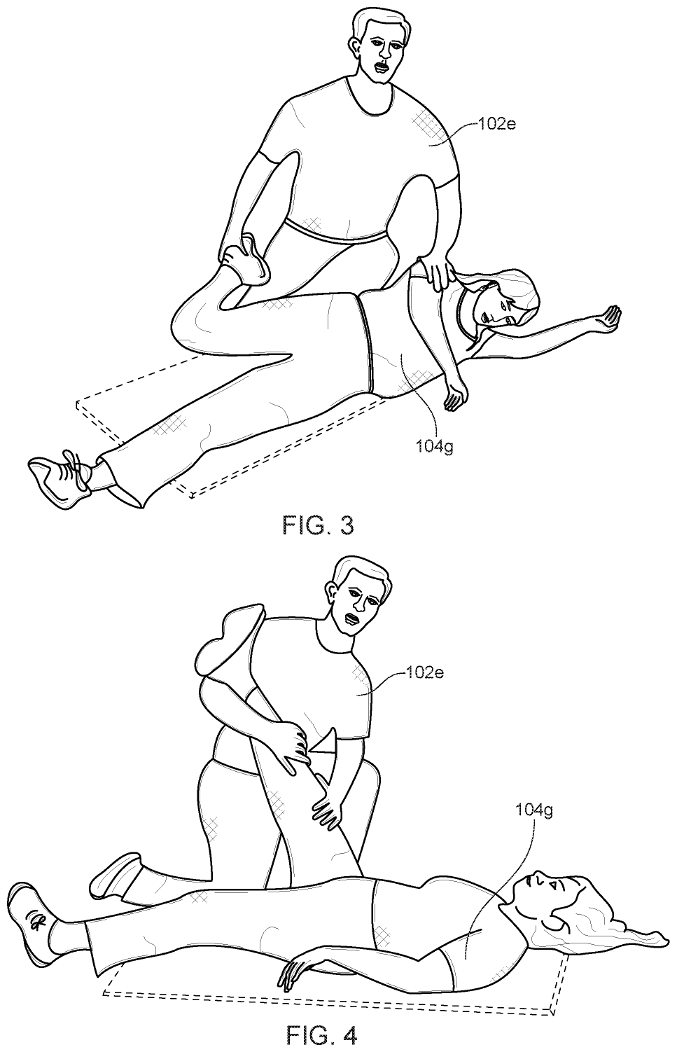

Referring to FIG. 3-5 of the drawing, the coach 102e positions and maintains the shoulders and the feet of a facility member 104g in a proper stretch position, at the proper tension, and for an appropriate amount of time. The coach 102e helps the facility member 104g in a slow, gradual fashion, with the feet stretched so far as it can go without discomfort.

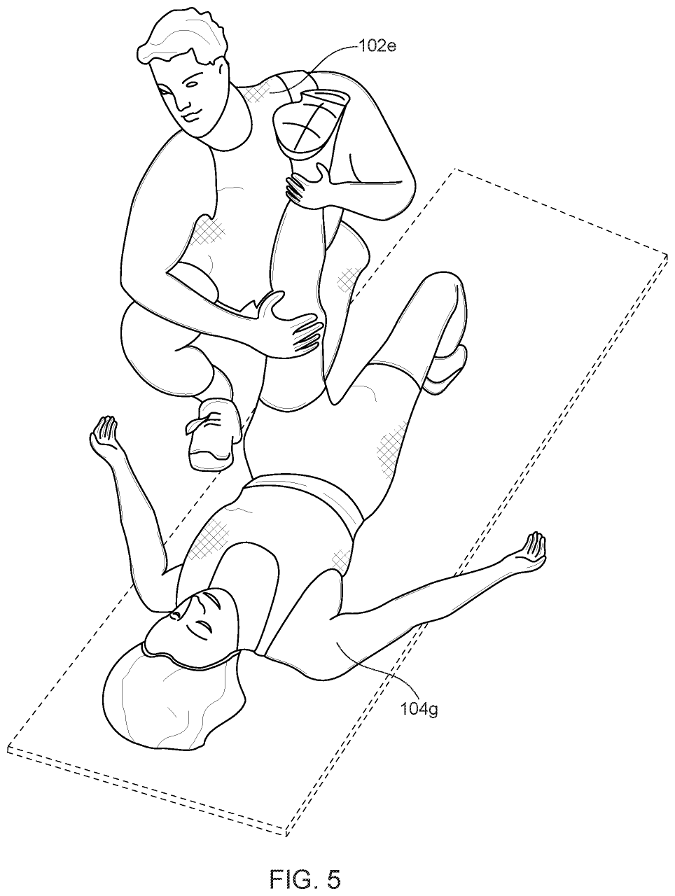

As shown in FIGS. 4 and 5, the coach 102e positions and maintains the legs of a facility member 104g in a proper stretch position, at the proper tension, and for an appropriate amount of time. The coach 102e helps the facility member 104g in a slow, gradual fashion, with the feet stretched so far as it can go without discomfort.

As shown in FIG. 5, the coach 102e positions, maintains, and bends the legs of a facility member 104g in a proper stretch position, at the proper tension, and for an appropriate amount of time. The coach 102e helps the facility member 104g in a slow, gradual fashion, with the feet stretched so far as it can go without discomfort

In one embodiment, the facility member 104a-g can perform the art of falling class in the stretching portion 112, wherein the coach 102a-e may provide the art of falling classes to the facility member 104a-g, or the facility member 104a-g can perform the Pilates classes by themselves. It is worth to mention that the facility member 104a in the stretching portion can be guided by the coach 102a-e hand-in-hand, and perform falling in a safer manner. The more flexible person can easily correct a loss of balance and roll over with the falling.

In another embodiment, the facility member 104a-g can perform stair climbing classes in the stretching portions 112. After injury or surgery, stair climbing is an important part of a physical therapy program. In addition, stair-climbing is a healthy activity for the elderly to build and maintain balance and coordination for healthy bones, muscles, and joints. The coach 102a-e may provide the stair climbing classes to the facility member 104a-g, wherein the stretching facility 100 and method 200 may comprise stair-climbing machines configured to allow the facility member 104a-f for performing the stair climbing classes. For example, stair climbing machines can be stair climbers or steps.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process flow diagrams for the sake of brevity. In some embodiments, some or all the process steps shown in the process flow diagrams can be combined into a single process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A stretching facility for stretching and strengthening muscles, the stretching facility comprising:
at least one coach;
an entry portion for regulating entry into the stretching facility;
a stretching portion for stretching muscles and tendons, whereby the coach positions and maintains the muscles and tendons in a stretch position, at tension, and for a duration;
a strengthening portion for strengthening the muscles, whereby the coach provides resistance to the muscles;
a balancing portion for increasing balance and stability, whereby the coach stabilizes leg muscles and core muscles;
a dry heat portion for relaxing the muscles and exfoliating skin;
a wet heat portion for relaxing the muscles and exfoliating skin; and
a relaxing portion for reducing tension in the muscles.

2. The stretching facility of claim 1, wherein the coach comprises a personal trainer.

3. The stretching facility of claim 1, wherein the coach assists a facility member in the stretching portion, the strengthening portion, the balancing portion, and the relaxing portion.

4. The stretching facility of claim 1, wherein the entry portion comprises a desk and a member identification device.

5. The stretching facility of claim 1, wherein the stretching portion, the strengthening portion, and the balancing portion comprise a gym.

6. The stretching facility of claim 1, wherein the coach positions and maintains the muscles and tendons in the stretching portion, through at least one of the following: deep tissue massage, Swedish massage, trigger point massage, and sports massage therapy.

7. The stretching facility of claim 1, wherein the stretching portion comprises elastic bands and a stretching table.

8. The stretching facility of claim 1, wherein the strengthening portion comprises an exercise ball and weights.

9. The stretching facility of claim 1, wherein the balancing portion comprises a balance board, a balance beam, and a stability ball.

10. The stretching facility of claim 1, wherein the dry heat portion comprises a sauna.

11. The stretching facility of claim 1, wherein the wet heat portion comprises a spa.

12. The stretching facility of claim 1, wherein the relaxing portion reduces tension in mind.

13. The stretching facility of claim 1, wherein the relaxing portion comprises a yoga mat, a padded supportive panel, a juice bar, and a recording of a lecture or music.

14. The stretching facility of claim 1, wherein the relaxing portion is engaged after engaging at least one of the following: the stretching portion, the strengthening portion, the balancing portion, the dry heat portion, and the wet heat portion.

15. The stretching facility of claim 1, further comprising an attire changing portion.

16. The stretching facility of claim 16, wherein the attire changing portion comprises a shower and a locker.

17. A stretching facility for stretching and strengthening muscles, the stretching facility consisting of:
at least one coach;
an entry portion for regulating entry into the stretching facility, the entry portion comprising a desk and a member identification device;
a stretching portion for stretching muscles and tendons, the stretching portion comprising elastic bands and a stretching table, (message table is mentioned right here) whereby the coach positions and maintains the muscles and tendons in a stretch position, at tension, and for a duration;
a strengthening portion for strengthening the muscles, the strengthening portion comprising an exercise ball and weights, whereby the coach provides resistance to the muscles;
a balancing portion for increasing balance and stability, the balancing portion comprising a balance board, a balance beam, and a stability ball, whereby the coach stabilizes leg muscles and core muscles;
a sauna for relaxing the muscles and exfoliating skin;
a spa for relaxing the muscles and exfoliating skin;
a relaxing portion for reducing tension in the muscles, the relaxing portion comprising a yoga mat, a padded supportive panel, a juice bar, and a recording of a lecture or music; and
an attire changing portion comprising a shower and a locker.

18. The stretching facility of claim 18, wherein the coach positions and maintains the muscles and tendons in the stretching portion, through at least one of the following: deep tissue massage, Swedish massage, trigger point massage, and sports massage therapy.

19. A method for stretching and strengthening muscles in a stretching facility, the method comprising:
providing a stretching facility, the stretching facility comprising an entry portion, a stretching portion, strengthening portion, a balancing portion, a dry heat portion, a wet heat portion, and a relaxing portion;
providing a coach for assisting a member facility in stretching and strengthening muscles;
stretching muscles and tendons in the stretching portion, whereby the coach positions and maintains the muscles and tendons in a stretch position, at tension, and for a duration;
strengthening the muscles in the strengthening portion, whereby the coach provides resistance to the muscles;
increasing balance and stability in the balancing portion, whereby the coach stabilizes leg muscles and core muscles;
relaxing the muscles and exfoliating skin in the dry heat portion;
relaxing the muscles and exfoliating skin in the wet heat portion; and
reducing tension in the muscles in the relaxing portion.
